(19) United States
(12) Patent Application Publication
(10) Pub. No.: US 2008/0312875 A1
(43) Pub. Date: Dec. 18, 2008

(54) Monitoring and control of integrated circuit device fabrication processes

(76) Inventors: Guanyuan M. Yu, San Jose, CA (US); Michael V. Williamson, San Jose, CA (US); Spencer B. Graves, San Jose, CA (US)

Correspondence Address: OKAMOTO & BENEDICTO, LLP, P.O. BOX 641330, SAN JOSE, CA, 95164, US

(21) Appl. No.: 11/811,802

(22) Filed: Jun. 12, 2007

(51) Int. Cl. G06F 19/00

(52) U.S. Cl. 702/182

(57) ABSTRACT

An integrated circuit (IC) device fabrication process may be monitored by processing product wafers to fabricate product IC devices, collecting process tool data from tools used to fabricate the product IC devices, and testing the product IC devices. To predict and monitor yield, the process tool data collected during processing and the defectivity data from testing the product IC devices may be input to a yield model that also takes into account design information particular to the product devices. The design information may comprise layout attributes of the product devices. The yield model may be generated from a defectivity model created by processing test wafers to fabricate test structures, collecting process tool data from tools used to fabricate the test structures, and testing the test structures. The test structures may have varying layout attributes to cover a design space allowed by design rules for particular product IC devices.

### BACKGROUND OF THE INVENTION

1. Field of the Invention

The present invention relates generally to integrated circuit devices, and more particularly to integrated circuit device fabrication process control.

2. Description of the Background Art

Integrated circuit (IC) devices are generally fabricated on a substrate, such as a semiconductor wafer. The wafer is subjected to various fabrication processing steps to form dopant regions, dielectric layers, metal layers with metal lines, vias providing electrical connection between metal lines on different levels, trenches, and other regions and structures. The fabrication processing steps are generally well known and may include diffusion, implantation, deposition, electroplating, chemical-mechanical polishing (CMP), annealing, lithography, and etching, for example. The fabrication processing steps result in an integrated circuit device formed in one or more levels of the wafer. Several integrated circuit devices are typically formed on a single wafer. The integrated circuit devices are tested at different steps in the fabrication process to insure that they operate as designed. The tests allow for identification of defective devices so that they may be separated from good devices. The yield of a fabrication process is a measure of the number of good structures, self-contained devices, or regions relative to defective ones fabricated using the process.

Various process control mechanisms may be employed to monitor and control fabrication processes. However, fabrication processes remain relatively difficult to monitor and control due to their complexity and the large number of processing variables involved. Embodiments of the present invention provide process control techniques that may be effectively used to monitor and control fabrication processes to meet yield requirements for particular devices.

### SUMMARY

An integrated circuit (IC) device fabrication process may be monitored by processing product wafers to fabricate product IC devices, collecting process tool data from tools used to fabricate the product IC devices, and testing the product IC devices. To predict and monitor yield, the process tool data collected during processing and the defectivity data from testing the product IC devices may be input to a yield model that also takes into account design information particular to the product devices. The design information may comprise layout attributes of the product devices. The yield model may be generated from a defectivity model created by processing test wafers to fabricate test structures, collecting process tool data from tools used to fabricate the test structures, and testing the test structures. The test structures may have varying test layout attributes to cover a design space allowed by design rules for particular product IC devices.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a system for generating a yield impact model in accordance with an embodiment of the present invention.

FIG. 2 schematically shows an example test structure in accordance with an embodiment of the present invention.

FIG. 3 shows a flow diagram of a method of creating a yield impact model in accordance with an embodiment of the present invention.

FIG. 4 shows a flow diagram of a method of monitoring an integrated circuit device fabrication process in accordance with an embodiment of the present invention.

FIGS. 5 and 6 show example plots of defectivity data versus a layout attribute in accordance with embodiments of the present invention.

The use of the same reference label in different drawings indicates the same or like components.

### DETAILED DESCRIPTION

In the present disclosure, numerous specific details are provided, such as examples of apparatus, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

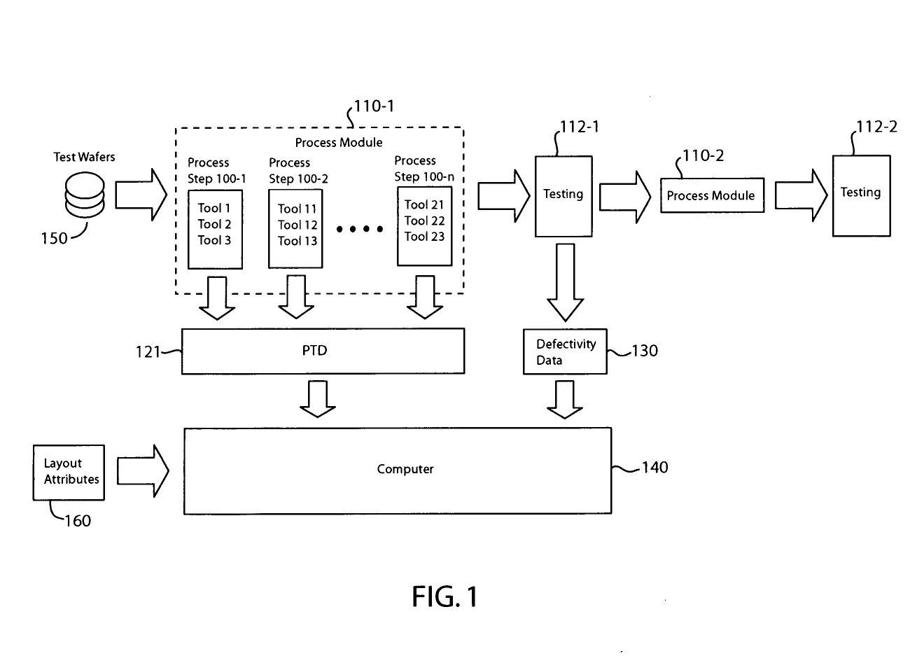

FIG. 1 shows a schematic diagram of a system for generating a yield impact model in accordance with an embodiment of the present invention. In the example of FIG. 1, a fabrication process may comprise one or more process modules 110 (i.e., 110-1, 110-2, . . . ), with each process module 110 comprising one or more process steps 100 (i.e., 100-1, 100-2, . . . ). A process module 110 may comprise a set of process steps 100 for fabricating a structure or region of the integrated circuit device. A process step 100 may be a chemical vapor deposition step, CMP, electroplating, physical vapor deposition step, diffusion step, etching step, lithography step, or other device fabrication step. Each process step 100 is performed in a device fabrication equipment commonly referred to as a “processing tool” or simply “tool.” A given fabrication facility may have more than one tool to perform a process step. In process module 110-1 of FIG. 1, the process step 100-1 may be performed in tool 1, tool 2, or tool 3. Likewise, the process step 100-2 may be performed in tool 11, tool 12, or tool 13, and a process step 100-n may be performed in tool 21, 22, 23, etc. A fabrication facility may have more or less tools for a particular process step but only a few are shown in FIG. 1 for clarity of illustration.

In the example of FIG. 1, the flow diagram begins with characterization vehicles in the form of test wafers 150 being processed through the process module 110-1. The test wafers 150 may comprise so-called “short flow characterization vehicles” in that each of them will be processed through a process module to build test structures, also referred to as “test chips,” designed for evaluating process steps of the process module. For example, the test wafers 150 may be processed to include test structures for testing formation of a first metal level (“M1”), a second metal level (“M2”), a via electrically connecting the first and second metal levels, etc. Typically but not necessarily, the test wafers 150 do not contain any product devices (i.e., devices for commercial sale). The test wafers 150 may comprise, for example, CV® test chips (or other characterization vehicles) from PDF Solutions, Inc., of San Jose, Calif. Other test wafers may also be used without detracting from the merits of the present invention. Test wafers with structures for evaluating process steps and yields are also disclosed in the following commonly-assigned disclosures, which are incorporated herein by reference in their entirety: U.S. Pat. No. 6,449,749; U.S. Pat. No. 6,475,871; U.S. Pat. No. 6,795,952; and U.S. Pat. No. 6,834,375.

Each test wafer 150 may be run through the process steps 100 of a process module 110 to build the test structures. For example, tool 1 in process step 100-1 may process a test wafer 150 to build a portion of a test structure, tool 12 in process step 100-2 may process the test wafer 150 to build another portion of the test structure, and so on. In one embodiment, the process tool data (PTD) 121, also referred to as “Fault Detection and Classification” data, comprise process parameters by which a wafer is processed by a tool and may cause a defect in the processed wafer. That is, each data in the PTD 121 may be a process parameter that may impact the fabricated structure or region on the wafer, and it also may be the statistics calculated from the time trace of such process parameters. The PTD 121 may depend on the type of the tool and may include, for example, process temperature, CMP pad pressure, slurry flow, bias voltage, etc., and the statistics may be mean values, minimum values, etc. of the process parameters. As a particular example, assuming tool 1 of the process step 100-1 is a PVD tool and the process step 100-2 is an etcher, the PTD 121 may include gas flow and coil current of tool 1 and etch bias voltage and chamber pressure of tool 2. The PTD 121 may be provided by their respective tools, and may be collected from the tools' sensor and configuration data for collection in the computer 140 over a computer network, for example.

The PTD 121 may include high frequency or low frequency data of the tools. High frequency data are those that occur whenever a wafer is processed. Examples of high frequency data include pad pressure, slurry flow, gas flow, chamber pressure, etch bias voltage, etc. In contrast, low frequency data are those that only occur from time to time and not during every wafer run. Examples of low frequency data include preventive maintenance schedules, time intervals between wafer processing, etc.

Test structures in the test wafers 150 may be tested after processing through one or more process modules 110. The tests may be performed by probing or non-probing means (e.g., e-beam by voltage contrasts). In the example of FIG. 1, the test wafers 150 are subjected to an electrical testing 112 (i.e., 112-1, 112-2, . . . ) after processing through a process module 110. An electrical testing 112 may look for various defects, such as opens and shorts, in the test structures in the test wafers 150.

The defectivity data 130 may comprise defects found in the test wafers 150. Particular examples of defectivity data may include an open via, a shorted metal line on a metal level, an open metal line on a metal level, etc. The defectivity data 130 may be in the form of fail rate or defect density (D₀), for example. Fail rate may be expressed in number of fails per feature count (e.g., contact fail rate of 1 fail per 1 billion contacts), and defect density may be expressed in defects per cm².

Each test wafer 150 may comprise a plurality of test structures that cover the design space allowed by a particular set of design rules. In one embodiment, a test wafer 150 includes test structures that incorporate design information, such as layout attributes, of product devices that may be processed in one or more process modules. The layout attributes may comprise physical arrangements of features of a product device, including metal line width, pitch, spacing, density, etc. The test structures may be designed to satisfy an experiment to determine the effect of varying layout attributes to defectivity. For example, the test structures in a test wafer 150 may be fabricated with different line widths, pitch, spacing, etc. to cover the range of variations these features may be fabricated per the design rules.

The computer 140 may comprise a computer or interconnected computers configured to collect PTD 121 and defectivity data 130. The computer 140 may also receive design information, such as layout attributes 160 of test structures in the test wafers 150. The computer 140 may include software packages for performing statistical analysis and other data processing to allow for generation of a yield impact model that takes into account layout attributes, process tool data, and defectivity data.

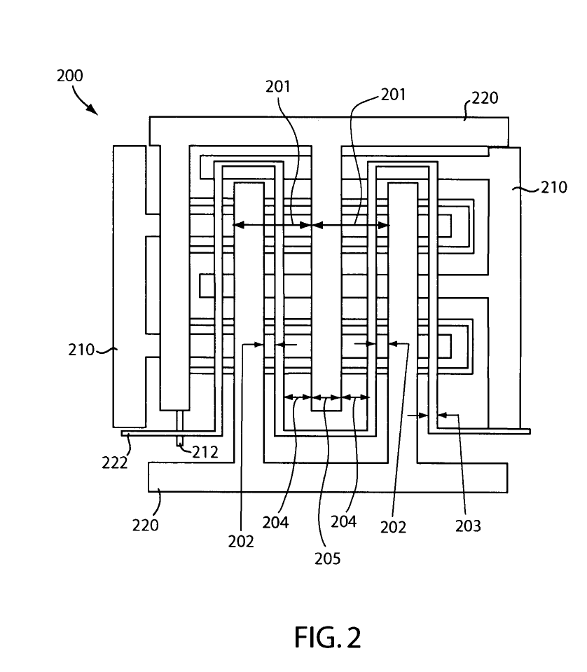

FIG. 2 schematically shows an example test structure 200 in accordance with an embodiment of the present invention. A plurality of test structures 200 with varying layout attributes dimensions may be present in the test wafers 150. In the example of FIG. 2, the test structure 200 includes a snake 212 and combs 210 in a first metal level to represent metal lines in a first metal level. The test structure 200 also includes a snake 222 and combs 220 in a second metal level above the first metal level, to represent metal lines in a second metal level. Test structure configurations other than snake and comb may also be used without detracting from the merits of the present invention.

In the example of FIG. 2, dimensions 201 correspond to pitch, dimensions 202 correspond to a first spacing, dimensions 204 correspond to a second spacing, dimension 205 corresponds to the width of the comb, and dimension 203 corresponds to the width of the snake. The layout attributes of the test structure 200 may represent a layout attribute in a product device. Each test structure in the test wafers 150 may have varying layout attribute dimensions to get defectivity data for the range of dimensions allowed by design rules for product devices. For example, the dimensions 201 may have a first value in a first test structure 200, have a second value different from the first value in a second test structure 200, and so on. An example application for the test structure 200 is to measure the impact of metal density and line width in the first and second metal levels on opens and shorts in the second metal level.

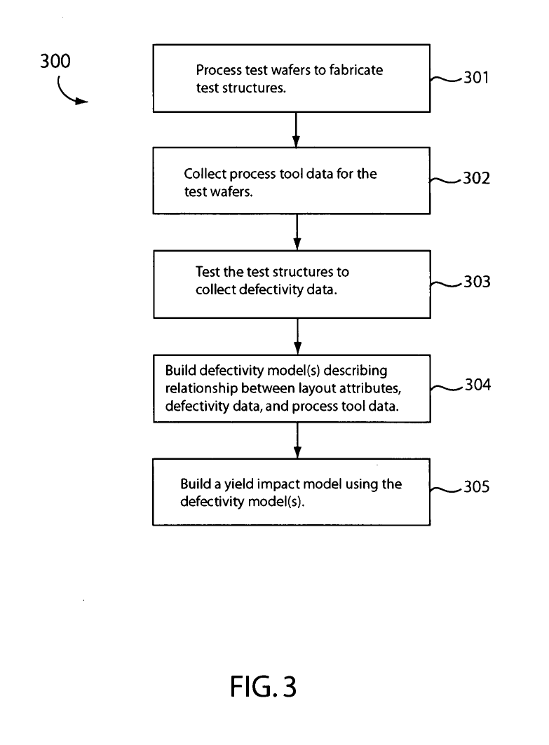

FIG. 3 shows a flow diagram of a method 300 of creating a yield impact model in accordance with an embodiment of the present invention. The method 300 begins with processing of test wafers to fabricate test structures (step 301). Each of the test wafers may have a plurality of test structures with layout attributes and corresponding dimensions covering the design space allowed by design rules of one or more product devices. Process tool data from tools used to fabricate the test wafers are collected (step 302). The test structures in the test wafers are tested after fabrication to collect defectivity data (step 303).

One or more defectivity models describing the relationship between layout attributes, defectivity data, and process tool data are built after the testing of the test wafers (step 304). In one embodiment, a defectivity model may be created by performing regression analysis and fitting to the collected process tool data and defectivity data to express defectivity as a function of process tool data and layout attribute.

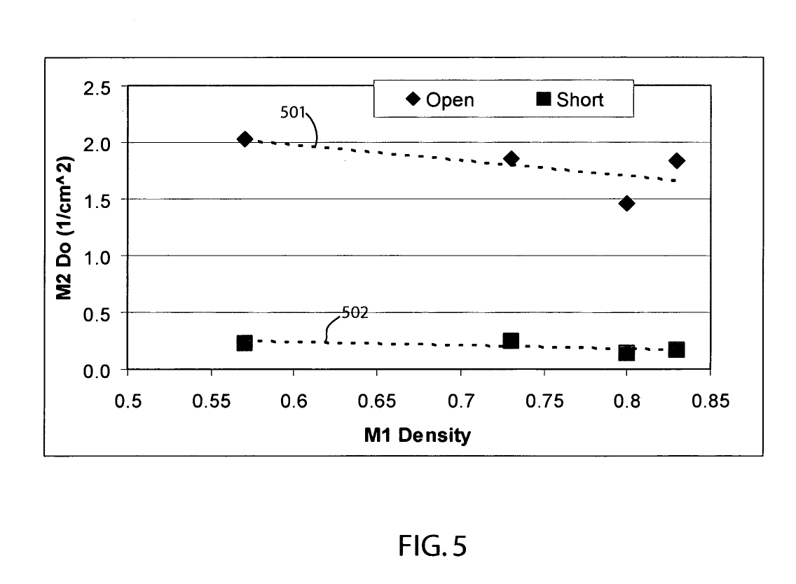

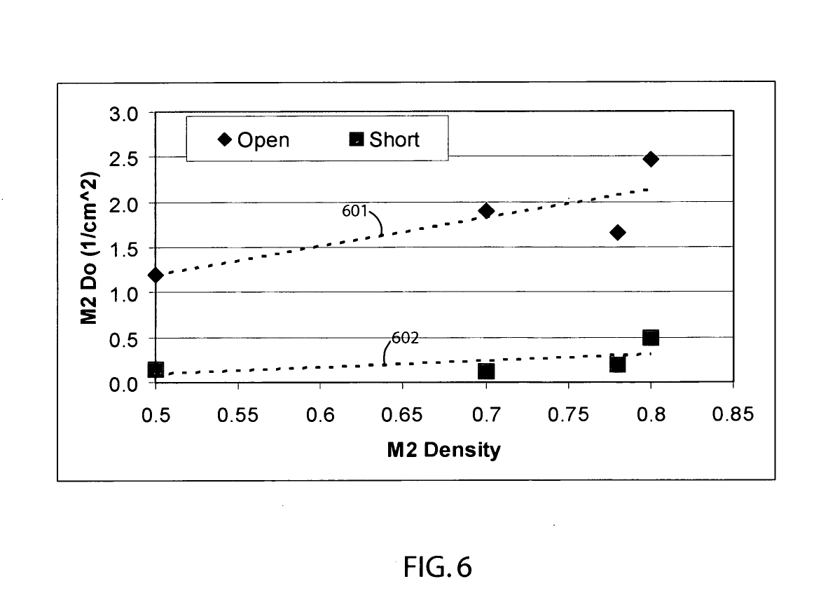

FIGS. 5 and 6 show example plots of defectivity data versus a layout attribute in accordance with embodiments of the present invention. In this example, the defectivity data comprise defect density for open and shorted metal lines, while the layout attribute comprises metal level density. Data for creating the plots of FIGS. 5 and 6 may come from fabrication and testing of test wafers, as previously described with reference to FIG. 1.

In the example of FIG. 5, the horizontal axis represents density of the first metal level, which may be represented by the snake 212 and combs 210 (see FIG. 2), and the vertical axis represents defect density for open and shorted metal lines found in the second metal level during testing. Plot 501 is the plot of open metal lines in the second metal level versus density of the first metal level, while plot 502 is the plot of shorted metal lines in the second metal level versus density of the first metal level. Generally speaking, the plots 501 and 502 show the effect of the density of the first metal level to opens and shorts in the second metal level.

Similarly, in the example of FIG. 6, the horizontal axis represents density of the second metal level, which may be represented by the snake 222 and combs 220 (see FIG. 2), and the vertical axis represents defect density for open and shorted metal lines found in the second metal level during testing. Plot 601 is the plot of open metal lines in the second metal level versus density of the second metal level, while plot 502 is the plot of shorted metal lines in the second metal level versus density of the second metal level. The plots 601 and 602 show the effect of the density of the second metal level to opens and shorts in the second metal level.

The plots of FIGS. 5 and 6 may be created from defectivity data from testing the wafers, and layout attributes of test structures in the test wafers. Using the collected process tool data and defectivity data along with the layout attributes of the test structures, regression analysis and fitting may be employed to represent defect density of opens and shorts in the second metal level as a function of density of the first and second metal levels and process tool data. For example, this can be shown in equation 1,

D₀=k₀+k₁M1_{DENSITY}+k₂M2_{DENSITY} (EQ. 1)

where D₀ is the defect density of opens and shorts in the second metal level, k₀ is a constant coefficient, k₁ is the slope of the plot of defect density versus density of the first metal level, k₂ is the slope of the plot of defect density versus density of the second metal level, M1_{DENSITY} is the density of the first metal level, and M2_{DENSITY} is the density of the second metal level. Equation 1 assumes a linear relationship in this example, but this is not necessarily the case. As can be appreciated, the principles disclosed herein may be extended to non-linear relationships.

k₀, k₁, k₂ can be further expressed as a function of process tool data based on defectivity data and process tool data for a given layout attribute, either as a linear relationship or non-linear relationship. For example, equation 1 may be expanded as in equation 2 to take into account process tool data,

$${D}_{0} = ( {a}_{1} {a}_{2} {a}_{3} … {a}_{n} ) ( \begin{matrix}{PTD}_{1} \\ {PTD}_{2} \\ {PTD}_{3} \\ ⋯ \\ {PTD}_{n}\end{matrix} ) + ( {b}_{1} {b}_{2} {b}_{3} … {b}_{n} ) ( \begin{matrix}{PTD}_{1} \\ {PTD}_{2} \\ {PTD}_{3} \\ ⋯ \\ {PTD}_{n}\end{matrix} ) M {1}_{DENSITY} + ( {c}_{1} {c}_{2} {c}_{3} … {c}_{n} ) ( \begin{matrix}{PTD}_{1} \\ {PTD}_{2} \\ {PTD}_{3} \\ ⋯ \\ {PTD}_{n}\end{matrix} ) M {2}_{DENSITY} \qquad ( EQ . 2 )$$

where a₁a₂a₃ . . . aₙ, b₁b₂b₃ . . . bₙ, c₁c₂c₃ . . . cₙ etc. are coefficients and PTD₁, PTD₂, PTD₃ . . . PTDₙ are process tool data, M1_{DENSITY} is the density of the first metal level, and M2_{DENSITY} is the density of the second metal level.

Equation 1 may be generalized as a defectivity model as shown in equation 3,

$$\begin{matrix}D = Co + {Do}^{1} + {Do}^{2} + … + {Do}^{n} \\ = {C}_{0} + {S}_{1} {Attribute}_{1} + {S}_{2} {Attribute}_{2} + … + {S}_{n} {Attribute}_{n}\end{matrix} \qquad ( EQ . 3 )$$

where D is the defectivity in defect density or fail rate depending on the defect, C₀ is a constant coefficient, S₁ is the slope of the plot of defectivity versus the first layout attribute, S₂ is the slope of the plot of defect density versus the second layout attribute, Sₙ is the slope of the plot of defect density versus the nth layout attribute, Attribute₁ is the first layout attribute, Attribute₂ is the second layout attribute, and Attributeₙ is the nth layout attribute. Here, C₀, S₁, S₂ are functions of process tool data. One way of determining the relationship between C₀, S₁, S₂ and process tool data is to align the process tool data with corresponding defectivity data for a given layout attribute using a regression algorithm, such as stepwise regression, for example.

Referring back to FIG. 3, a yield impact model may be generated using the defectivity model (step 305). As can be appreciated, a yield may be a “final” (i.e., overall) yield of an entire fabrication process or a “limited” (i.e., partial) yield of the process. In this disclosure, the term “yield” refers to either a final or limited yield depending on the context. For example, the yield of a process module may be a limited yield if there are other process modules that affect the overall yield of the process. On the other hand, the yield of a process module may be the overall yield if the only yield loss in the entire process is due to that process module.

In general, the yield Y for a specific product may be represented as:

$$\begin{matrix}Y = {e}^{- {\sum }_{i ∈ ( set of layout attributes )} {D}_{o}^{i} \times {A}^{i} c ( p )} \\ or & ( EQ . 4 ) \\ Y = {e}^{- {\sum }_{i ∈ ( set of layout attributes )} {λ}^{i} \times {N}^{i}} & ( EQ . 5 )\end{matrix}$$

Where Aⁱc(p) is the critical area for a given layout attribute i, D₀ⁱ is defect density or defect density penalty for a given layout attribute i, λⁱ is the fail rate or fail rate penalty for a given layout attribute i, and Nⁱ is the feature count for the fail rate for a given layout attribute i. The defectivity model of equation 3 provides the defectivity, which may be in defect density D₀ⁱ or fail rate λⁱ, and may be substituted in either equation 4 or 5 to give the yield impact model.

The above-described yield impact model provides several advantages heretofore unrealized. Firstly, taking into account layout attributes in generating the yield impact model allows for a better estimate of the effect of particular process tool data that impact several defectivity data. Secondly, when the differential impact of particular process tool data depends on a layout attribute, the yield impact model provides more information about that differential impact. Thirdly, because the defectivity model incorporates process tool data and layout attributes, the yield impact model may be employed to determine the yield impact of process tool data for particular layout attributes. For example, layout attribute data of a particular product device may be input to the yield impact model. During processing of the product device, process tool data from a tool processing the device may be input to the yield impact model to determine if the operating process conditions of the tool detrimentally impact the yield. By inputting layout attributes of the product device into the yield impact model, the yield impact model generates a response tailored for the product device. As can be appreciated, this advantageously allows tool monitoring to be optimized for particular devices, each of which may have particular layout attributes.

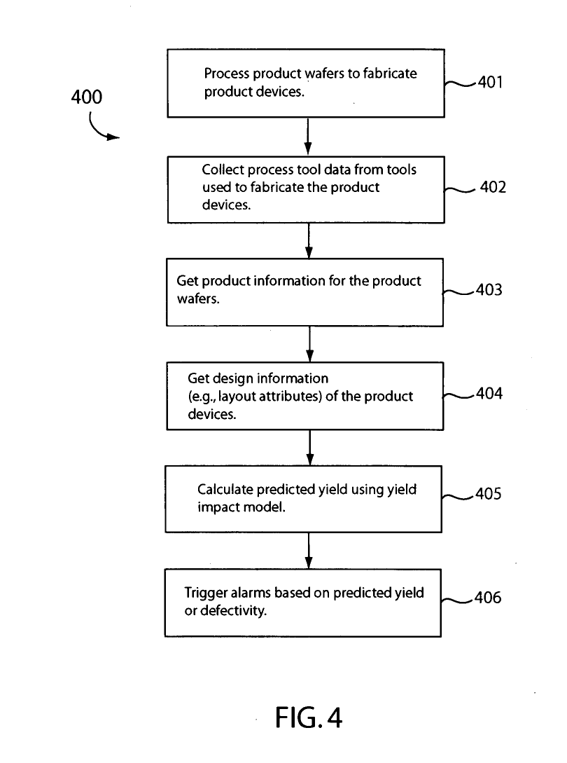

FIG. 4 shows a flow diagram of a method 400 of monitoring an integrated circuit device fabrication process in accordance with an embodiment of the present invention. The method 400 takes advantage of a yield impact model generated using a defectivity model that takes into account layout attributes and process tool data as in the method 300 of FIG. 3. In the example of FIG. 4, a tool employed to perform a fabrication step is monitored to conform to a minimum yield requirement.

The method 400 begins with product wafers being processed in tools to fabricate product integrated circuit devices (step 401). Process tool data are collected from the tools during processing (402). Product information for the product wafers is collected (step 403). The product information may identify the product devices being fabricated in the product wafers and where to obtain design information for the product devices. Product information may be retrieved from a server computer in the fabrication facility, or recorded in a production manual or in documentation accompanying the product wafers. Design information particular to the product devices, such as pre-calculated layout attributes of the product devices, are obtained (step 404). Design information may be obtained from the factory server computer or looked up in design documents, for example.

The predicted yield of the fabrication process may be calculated by inputting the process tool data and the layout attributes of the product devices into the yield impact model (step 405). Alarms may be triggered based on the calculated predicted yield or defectivity (step 406). For example, alarms may be set to trigger when collected process tool data and layout attributes of the product devices being fabricated result in the yield impact model generating a predicted yield that is below a minimum yield requirement. As another example, alarms may be set to trigger when the defectivity is beyond a maximum defectivity requirement. For a device fabrication facility that processes many different types of products, the same process tool data may trigger an alarm for one type of product but not for another type of product, due to the difference of their layout attributes.

While specific embodiments of the present invention have been provided, it is to be understood that these embodiments are for illustration purposes and not limiting. Many additional embodiments will be apparent to persons of ordinary skill in the art reading this disclosure.

1. A method of monitoring an integrated circuit device fabrication process, the method comprising:
processing a plurality of product wafers containing product integrated circuit (IC) devices;
collecting process tool data from tools used to fabricate the product IC devices, the process tool data comprising process parameters by which the product wafers were processed to build structures in the product wafers and may cause a defect in the product wafers;
obtaining design information particular to the product IC devices; and
inputting the design information and the process tool data into a yield model to calculate a predicted yield of the fabrication of the product IC devices.

2. The method of claim 1 wherein the design information comprises layout attributes of the product IC devices, the layout attributes comprising physical arrangements of features in the product IC devices.

3. The method of claim 1 wherein the layout attributes include metal level density.

4. The method of claim 1 wherein the yield model is generated using a defectivity model that takes into account process tool data from tools that processed test wafers to fabricate test structures with varying layout attributes, the layout attributes of the test structures, and defectivity data from testing the test structures.

5. The method of claim 4 wherein the defectivity data include opens and shorts found on a metal level in the test structures.

6. The method of claim 4 wherein the test structures comprise comb and snake structures.

7. The method of claim 4 wherein the defectivity data from testing the test structures are in terms of fail rate.

8. The method of claim 4 wherein the defectivity data from testing the test structures are in terms of defect density or fail rate.

9. The method of claim 1 further comprising:
triggering an alarm when the predicted yield is below a minimum yield requirement or the predicted defectivity is beyond a maximum defectivity requirement.

10. The method of claim 1 wherein the yield model is generated using a method comprising:
fabricating test structures in test wafers, the test structures having varying layout attributes comprising physical arrangements of features in the test structures;
collecting process tool data from tools employed to process the test wafers, the process tool data comprising process parameters by which the test wafers were processed to fabricate the test structures;
testing the test structures to obtain defectivity data;
building a defectivity model describing a relationship between the layout attributes, the defectivity data, and the process tool data; and
building the yield model based on the defectivity model.

11. A system for generating a model of an integrated circuit device fabrication process, the system comprising:
a plurality of tools configured to perform processing steps on a plurality of test wafers to fabricate a plurality of test structures in the wafers;
a tester configured to test the plurality of test structures to generate defectivity data; and
a computer configured to receive process tool data from the plurality of tools, the defectivity data from the tester, and design information of the test structures to generate a yield model for calculating a yield of a fabrication process, the process tool data comprising process parameters by which the wafers were processed to build the test structures in the wafers and may cause a defect in the wafers.

12. The system of claim 11 wherein the design information comprises layout attributes of the test structures.

13. The system of claim 11 wherein the yield model is generated using a defectivity model that describes a relationship between the process tool data, layout attributes of the test structures, and the defectivity data.

14. A method of generating a model of an integrated circuit device fabrication process, the method comprising:
fabricating test structures in wafers, the test structures having varying layout attributes comprising physical arrangements of features in the test structures;
collecting process tool data from tools employed to process the test wafers, the process tool data comprising process parameters by which the test wafers were processed to build the test structures in the wafers and may cause a defect in the wafers;
testing the test structures to obtain defectivity data;
building a defectivity model describing a relationship between the layout attributes, the defectivity data, and the process tool data; and
building a yield model based on the defectivity model.

15. The method of claim 14 wherein the test structures comprise comb and snake.

16. The method of claim 14 the yield model is used to calculate a predicted yield of a fabrication process for processing product wafers to fabricate product IC devices.

17. The method of claim 16 wherein an alarm is triggered when the yield predicted for the fabrication process for processing the product wafers is below a minimum yield requirement or the predicted defectivity is beyond a maximum defectivity requirement.

18. The method of claim 17 wherein product information for the product IC devices is input to the yield model to calculate the predicted yield for the fabrication process for processing the product wafers.

19. The method of claim 18 wherein the product information comprises layout attributes of the product IC devices.

20. The method of claim 19 wherein the layout attributes include metal level density.
